(19) United States
(12) Patent Application Publication
(10) Pub. No.: US 2010/0170305 A1
(43) Pub. Date: Jul. 8, 2010

(54) TAMPER RESISTANT PORTABLE LOCK SHROUD

(76) Inventor: Kirk Edward Barr, Foresthill, CA (US)

Correspondence Address: Kirk Barr, P.O.Box 1471, Foresthill, CA, 95631, US

(21) Appl. No.: 12/350,221

(22) Filed: Jan. 7, 2009

(51) Int. Cl. E05B 67/38

(52) U.S. Cl. 70/56

(57) ABSTRACT

A portable shroud for a lock securing ends of a cable or chain includes a tubular element having sufficient interior dimensions to accommodate a plurality of locks where the dimensions mitigate attempts to reach the lock with a cutting means. At least two slots accept the ends of the cable or chain where only the ends can be inserted into the tubular element for engaging with the locks and where either end of the cable or chain can be removed from the shroud by disengaging a respective one or more locks. At least two tubes are joined to the tubular element where an end of each of the tubes covers the slots such that the ends of the cable or chain pass through the tubes and the tubes further mitigate attempts to reach the locks with the cutting means.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to locks. More particularly, the invention relates to a portable lock shroud to prevent lock tampering.

### BACKGROUND OF THE INVENTION

There has been a long time need to lock gates to keep out trespassers on private and public lands. Also there is a need to secure personal property with locks to prevent theft. However, locks can be cut off of the gates or property that they protect, therefore promoting the idea of lock protection, or lock shrouds.

There are many different kinds and styles of lock shrouds currently available. One option for a property owner to protect a lock on a gate is to hire a professional to come out to the site and fabricate a lock shroud to be permanently attached to the gate or gatepost. This, however, can be very costly and inconvenient especially if there are multiple gates on the same property. Other existing shrouds that can be used to protect locks on gates and personal property include a shroud that is made to fit its own specifically designed lock. This creates a problem with companies and agencies that use their own locks. Also, many situations involve multiple owners or agencies that need to gain access to the item being locked. Another shroud available is one that is prefabricated and designed to be permanently mounted on the item being locked, for example, without limitation, gates, barn doors, etc. This eliminates the possible use of this type of shroud on personal property items such as, but not limited to, motorcycles, bicycles, generators, items in the back of a pickup, etc. As described in the foregoing, these currently known lock shrouds tend to be situation specific. Furthermore, there are many available lock shrouds to fit a single lock; however, there are no currently known lock shrouds to protect two locks on the same gate.

A specific prior art device uses a chain secured around a gate or other item by a lock. This device has a steel shroud that fits over the top of the lock. The shroud is just big enough to fit over one lock to protect the body and shank of the lock. If two locks are needed, two shrouds must be used. Furthermore, this device is designed to only be used with a specially made lock and key.

In view of the foregoing, there is a need for improved techniques for providing a portable lock shroud that can be used in a multiplicity of situations including without limitation, on multiple locks. It is also desirable for the lock shroud to be simple, lightweight and convenient to use and transport.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1C illustrate an exemplary pipe shroud for a lock, in accordance with an embodiment of the present invention. FIG. 1A is a top view; FIG. 1B is a side view, and FIG. 1C is an end view;

FIGS. 2A and 2B illustrate two exemplary variations on a pipe shroud, in accordance with embodiments of the present invention. FIG. 2A is a top view of the pipe shroud with square tubing centered over the slots and attached to the pipe shroud. FIG. 2B is a top view of the pipe shroud with oval tubing centered over the slots and attached to the pipe shroud;

FIGS. 3A and 3B illustrate exemplary applications of a pipe shroud on a gate, in accordance with an embodiment of the present invention. FIG. 3A illustrates an application using two locks, and FIG. 3B illustrates an application using one lock;

FIG. 4 is a side view of an exemplary pipe shroud, in accordance with an embodiment of the present invention;

FIG. 5 is a side view of an exemplary pipe shroud, in accordance with an embodiment of the present invention; and

FIGS. 6A, 6B and 6C illustrate variations on an exemplary square shroud, in accordance with embodiments of the present invention. FIG. 6A is a top view of the square shroud with square tubing. FIG. 6B is a top view of the square shroud with oval tubing, and FIG. 6C is an end view of the square shroud with round stock.

Unless otherwise indicated illustrations in the figures are not necessarily drawn to scale.

### SUMMARY OF THE INVENTION

To achieve the forgoing and other objects and in accordance with the purpose of the invention, a tamper resistant portable lock shroud is presented.

In one embodiment, a portable shroud for a lock securing ends of a cable or chain is presented. The shroud includes a tubular element having sufficient interior dimensions to accommodate the lock and mitigate attempts to reach the lock with a cutting means. The tubular element has at least two slots for accepting the ends of the cable or chain where only the ends can be inserted into the tubular element for engaging with the lock. In another embodiment the least two slots accept the ends only to a point of a cable feral or next chain link preventing the cable or chain from being pulled through the slots. Other embodiments further include at least one tube joined to the tubular element where an end of the tube covers the slots such that the ends of the cable or chain pass through the tube and the tube further mitigates attempts to reach the lock with the cutting means and the at least one tube has an oval shape. Still other embodiments further include at least two tubes joined to the tubular element where an end of each of the tubes covers the slots such that the ends of the cable or chain pass through the tubes and the tubes further mitigate attempts to reach the lock with the cutting means and the at least two tubes have a rectangular shape. In another embodiment the tubular element further includes a plate joined to an end of the tubular element and the slots are contained in the plate. In yet another embodiment the interior dimensions are further sufficient to accommodate two locks where each of the locks engages an end of the cable or chain allowing either end of the cable or chain to be removed from the shroud by disengaging the respective lock. In still another embodiment the slots are in opposition. In yet other embodiment the tubular element has a generally rectangular shape and the tubular element further includes a plurality of round stock joined to internal corners of the tubular element for further mitigating attempts to reach the lock with the cutting means.

In another embodiment a portable shroud for a lock securing ends of a cable or chain is presented. The shroud includes means for accommodating the lock where the accommodating means mitigates attempts to reach the lock with a cutting means and means for accepting the ends of the cable or chain where only the ends can be inserted into said accommodating means. Another embodiment further includes means for passing the ends of the cable or chain through for further mitigating attempts to reach the lock with the cutting means.

In another embodiment a portable shroud for a lock securing ends of a cable or chain is presented. The shroud includes a tubular element having sufficient interior dimensions to accommodate a plurality of locks where the dimensions mitigate attempts to reach the lock with a cutting means. At least two slots accept the ends of the cable or chain where only the ends can be inserted into the tubular element for engaging with the locks and where either end of the cable or chain can be removed from the shroud by disengaging a respective one or more locks. At least two tubes are joined to the tubular element where an end of each of the tubes covers the slots such that the ends of the cable or chain pass through the tubes and the tubes further mitigate attempts to reach the locks with the cutting means. In another embodiment the least two slots accept the ends only to a point of a cable feral or next chain link preventing the cable or chain from being pulled through the slots. In another embodiment the at least two tubes have a rectangular shape. In still another embodiment the tubular element further includes a plate joined to an end of the tubular element and the slots are contained in the plate. In another embodiment the slots are in opposition. In yet other embodiments the tubular element has a generally rectangular shape and the tubular element further includes a plurality of round stock joined to internal corners of the tubular element for further mitigating attempts to reach the lock with the cutting means.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

A preferred embodiment of the present invention provides a portable, lightweight lock shroud. This lock shroud comprises a metal pipe with open ends and two slots cut in the center of the pipe. Placed over the slots are two metal tubings fastened to the pipe for example, without limitation, by welding. The preferred embodiment is used in conjunction with a cable or chain and one or more locks. In typical use of the preferred embodiment, the cable or chain is placed around the gate and gatepost. Then each end of the cable or chain is placed through the tubings, through the slots and into the pipe. The lock is then placed around the ends of the cable or chain inside the shroud and locked.

The preferred embodiment is novel in design and also solves problems to different situations. As stated in the background, prior art shrouds are often not adequate in various situations. For example, without limitation, most prior art shrouds must be bolted permanently to a post. This is difficult on metal gates. This also excludes the use of these types of shrouds for locking up personal property. Preferred embodiments of the present invention, being portable, can be used in practically any situation just by wrapping the cable or chain around the item being locked. Thereby making it easy to lock up personal property such as, but not limited to, motorcycles, bicycles, generators, toolboxes, or other items to secure objects for example, without limitation, in the back of a pickup truck, to a fence or post, to a bicycle rack, etc. Some prior art shrouds require the use of a specifically designed lock that cooperates with the particular shroud. This excludes agencies and companies that use their own locks such as, but not limited to, forestry agencies, PG@E, BLM, etc. from using these shrouds. Presently a big problem not met by prior art shrouds is the need to lock two separate keyed locks in the same shroud. Preferred embodiments enable multiple locks to be used in the same shroud. Preferred embodiments can be used with any lock, which makes these embodiments versatile and convenient. It is contemplated that the main users of preferred embodiments of the present invention would be public agencies and utility companies because of the two-lock feature; however, because of the versatility of preferred embodiments, they can virtually be used by any person to lock personal property, gates, doors, etc.

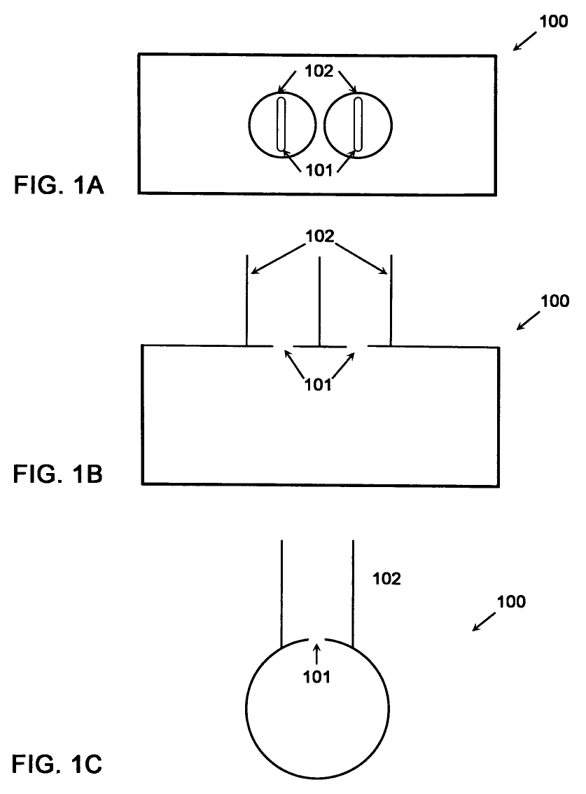

FIGS. 1A through 1C illustrate an exemplary pipe shroud 100 for a lock, in accordance with an embodiment of the present invention. FIG. 1A is a top view; FIG. 1B is a side view, and FIG. 1C is an end view. In the present embodiment, pipe shroud 100 comprises open ends, tubings 102 and slots 101. Pipe shroud 100 is sized to not enable cutters that are adequate for cutting locks to gain access to locks inside of pipe shroud 100. This size is preferably three inches in diameter; however, embodiments may be made in various different sizes to accommodate locks of different sizes. In the present embodiment, round tubings 102 are centered over slots 101. Round tubings 102 protect the lock shank from being tampered with through slots 101 by devices such as, but not limited to, saws, bolt cutters, etc. by blocking access to slots 101 Slots 101 are so designed to allow a cable or chain through only to the point of the cable feral or the next chain link. This generally prevents the cable or chain from being pulled through slots 101 to gain access to the lock inside pipe shroud 100 to be tampered with by devices such as, but not limited to, bolt cutters, hammers, lock picking devices, etc.

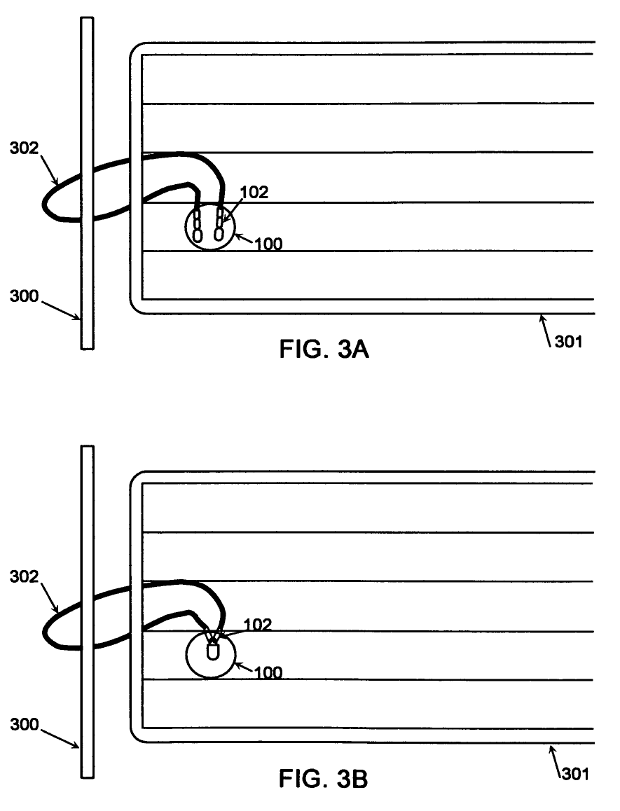

In typical use of the present embodiment, a user inserts one end of a cable through one of tubings 102 and then through one of slots 101 and attaches a lock to the end of the cable that is inside pipe shroud 100. Then the user wraps the cable around the item to be secured and inserts the other end of the cable through the other tubing 102 and through the other slot 101. The user then attaches this end of the cable to the lock on the other end of the cable or another lock and locks the lock or locks to secure the item. The present embodiment may be used to secure any type of item around which a cable or chain may be placed for example, without limitation, gates, bicycles, other types of vehicles, machinery, outdoor furniture, etc. Two exemplary applications of pipe shroud 100 on a gate are illustrated by way of example in FIGS. 3A and 3B.

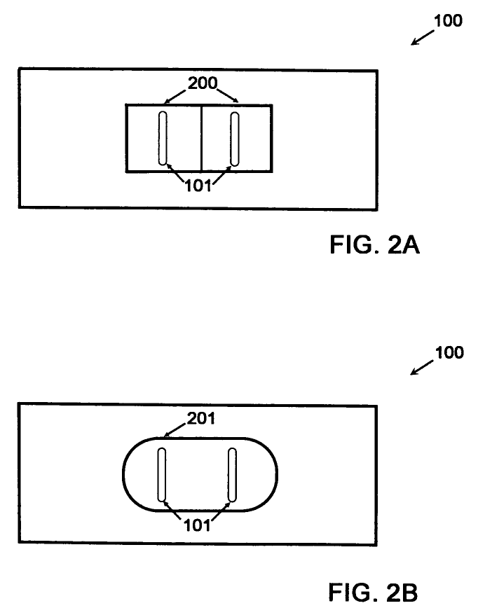

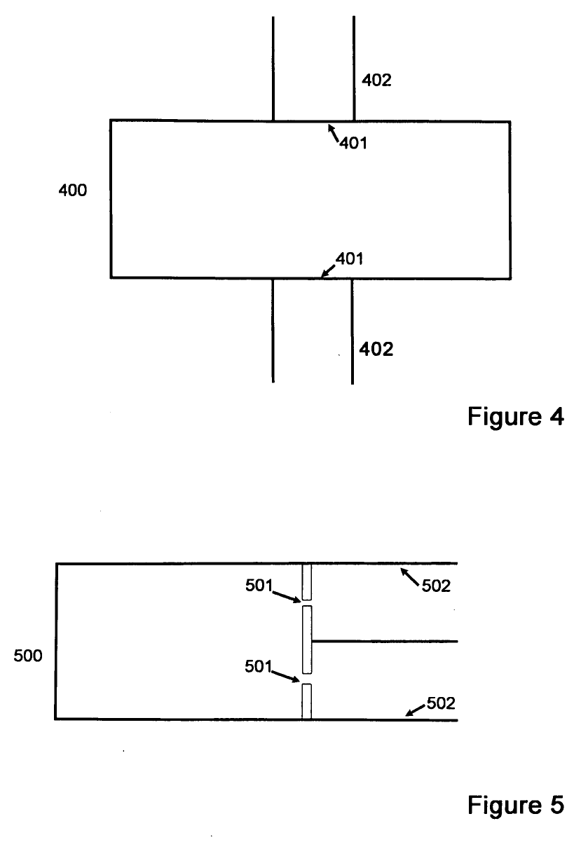

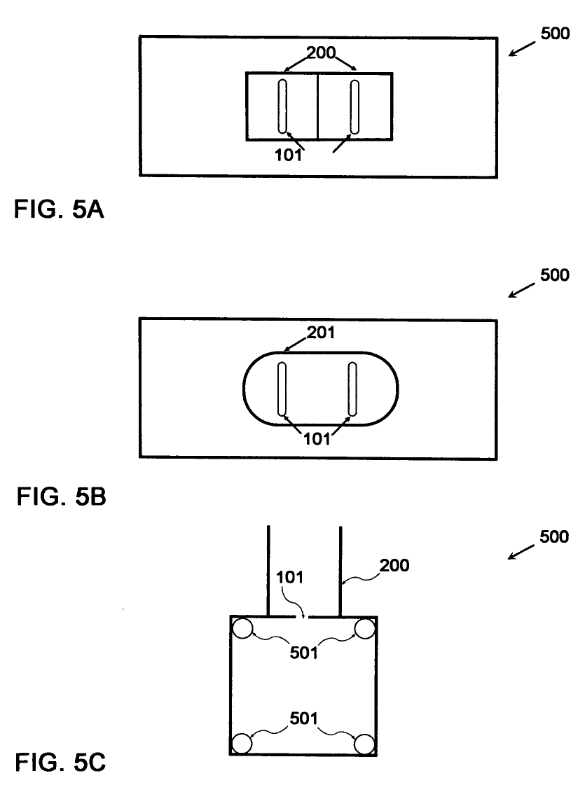

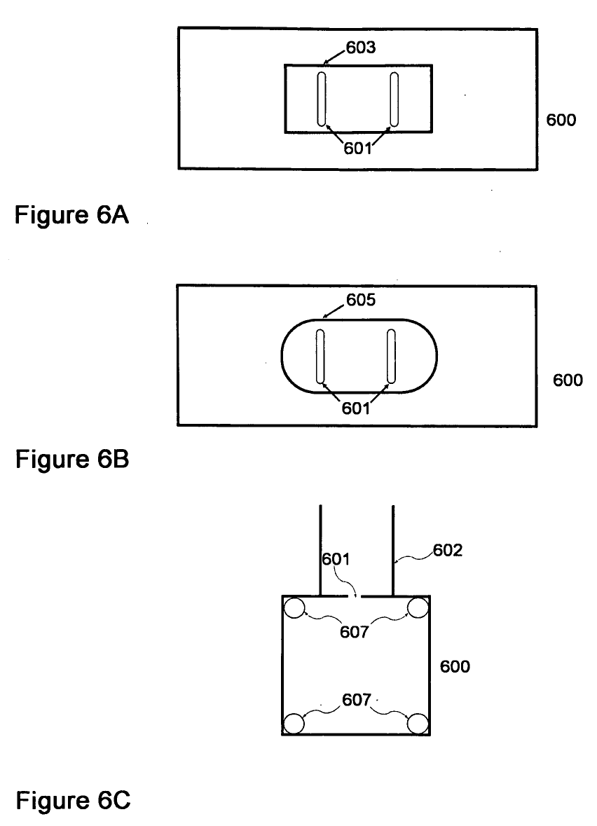

A preferred embodiment of the present invention comprises a 3″ metal pipe shroud that is ¼″ thick and 7½″ long with open ends, not attached to any structure. Two 5/16″ by 1½″ slots are cut into the top of the metal pipe shroud, and two metal tubings that are 0.065″ thick x1 ½″ wide and 2⅛″ long are notched to fit the radius of the 3″ pipe shroud and welded over the slots. The metal pipe shroud and tubings are preferably steel; however in alternate embodiments other materials may be used such as, but not limited to, other metals, plastics, acrylics, etc. However, by changing to an alternative material such as plastic, PVC, or other light materials, the security of the shroud may be lessened. Therefore, metal is the preferred material for shrouds needed for high security applications. Those skilled in the art, in light of the present teachings, will readily recognize that a multiplicity of suitable variations of sizes and shapes of pipe shrouds, slots and tubings may be incorporated into alternate embodiments such as, but not limited to, varying the gauge or thickness of the pipe or tubing, for example, without limitation, to 0.065″ thick, varying the diameter of the pipe or tubing, making the length of the pipe shorter or longer, varying the size of the slots to accommodate cables or chains of various size, etc. Other variations that may be incorporated into alternate embodiments include, without limitation, using tubings of various shapes such as, but not limited to, square or ovular as shown by way of example in FIGS. 2A and 2B, varying the location of the slots and tubing on the shroud as shown by way of example in FIGS. 4 and 5, using square pipe rather than circular pipe as shown by way of example in FIGS. 6A through 6C, using one longer or wider slot through which both ends of the cable or chain may fit rather than two slots, etc.

FIGS. 2A and 2B illustrate exemplary variations on a pipe shroud 100, in accordance with embodiments of the present invention. FIG. 2A is a top view of pipe shroud 100 with square tubing 200 centered over slots 101 and attached to pipe shroud 100. FIG. 2B is a top view of pipe shroud with oval tubing 201 centered over slots 101 and attached to pipe shroud 100. Alternate embodiments may incorporate various other shapes of tubing such as, but not limited to, rectangular tubing, triangular tubing, etc. The embodiments shown in FIGS. 2A and 2B are used in the same way as the embodiment shown by way of example in FIGS. 1A through 1C.

A preferred embodiment of the present invention enables the use of two different keyed locks in the same shroud for the purpose of enabling two separate owners or agencies to gain access through private or public property such as, but not limited to, gates to roads, utility yards, roads that agencies must be able to access, etc. Another aspect of use of preferred embodiments is using a single lock in the shroud for securing personal property such as, but not limited to, gates, barn doors, construction yards, items in the back of a pickup such as, but not limited to, motorcycles, bicycles, generators, etc.

FIGS. 3A and 3B illustrate exemplary applications of a pipe shroud 100 on a gate 301, in accordance with an embodiment of the present invention. FIG. 3A illustrates an application using two locks 303, and FIG. 3B illustrates an application using one lock 303. Referring to FIG. 3A a cable or chain 302 is placed around a gatepost 300 and gate 301. Then, one end of cable or chain 302 is placed through a piece of tubing 102 and through a slot into pipe shroud 100, and a lock 303 is connected to cable or chain 302. The other end of cable or chain 302 is placed through the other piece of tubing 102 and through the other slot into pipe shroud 100, and another lock 303 is connected to this end of cable or chain 302. This enables one party or the other to gain access to gate 301 by only unlocking their lock so that one end of cable or chain 302 becomes free to open gate 301.

Referring to FIG. 3B, cable or chain 302 is placed around gatepost 300 and gate 301. Then one end of cable or chain 302 is placed through a piece of tubing 102 and through a slot into pipe shroud 100, and the other end of cable or chain 302 is inserted through the other piece of tubing 102 and through the other slot into pipe shroud 100. Then, both ends of cable or chain 302 are connected with one lock 303.

Pipe shrouds according to the present embodiment can also be used in series by using a short cable or chain in between each pipe shroud. By using the same locking methods as described by way of example above, using two pipe shrouds in series can protect three or four locks while allowing three or four entities to gain separate access, and the use of three shrouds in series can protect five or six locks, etc.

Those skilled in the art, in light of the present teachings, will readily recognize that there is a multiplicity of suitable configurations for slots and tubing on shrouds according to alternate embodiments of the present invention, for example, without limitation, the embodiments shown by way of example in FIGS. 4 and 5. FIG. 4 is a side view of an exemplary pipe shroud 400, in accordance with an embodiment of the present invention. In the present embodiment, round tubing 402 is centered over slots 401 opposing each other and attached to pipe shroud 400. The present embodiment is used in the same manner as the previously described embodiments.

FIG. 5 is a side view of an exemplary pipe shroud 500, in accordance with an embodiment of the present invention. In the present embodiment, one end of pipe shroud 500 is closed off with a solid metal plate 503 comprising slots 501. Round tubing 502 is centered over slots 501 and attached to solid metal plate 503. The present embodiment is used in the same manner as previously described embodiments.

FIGS. 6A, 6B and 6C illustrate variations on an exemplary square shroud 600, in accordance with embodiments of the present invention. FIG. 6A is a top view of square shroud 600 with square tubing 603. FIG. 6B is a top view of square shroud 600 with oval tubing 605, and FIG. 6C is an end view of square shroud 600 with round stock 607. Referring to FIG. 6A, two pieces of square tubing 603 are centered over slots 601 and attached to square shroud 600. Referring to FIG. 6B, a piece of oval tubing 605 is centered over slots 601 and attached to square shroud 600. Those skilled in the art, in light of the present teachings, will readily recognize that various other types of tubing may be used to shied slots 601 such as, but not limited to, round tubing, rectangular tubing, triangular tubing, etc. Referring to FIG. 6C, tubing 602 that is centered over slots 601 and attached to square shroud 600 may be various different shapes such as, but not limited to, square, circular, ovular, rectangular, triangular, etc. In the present embodiment, a piece of round stock 607 is attached to each corner of square shroud 600 to generally prevent access to the lock within square shroud 600 with devices such as, but not limited to, bolt cutters.

In an alternate embodiment of the present invention, a pipe shroud comprises slots in the top of the pipe shroud into which cable loops or chain may be inserted to be attached to a lock or locks. The present embodiment does not include tubings around the slots. By removing the tubings from the main shroud, closer access to the lock shank may be gained for possible cutting. Therefore, the present embodiment may be more suited for applications that do not require maximum security. Other alternate embodiments may implement pipe shrouds with no tubings where the slots are located in various different locations on the pipe shroud for example, without limitation, on opposing sides, on a sealed end, etc.

In another alternate embodiment, the pipe shroud may be made of a transparent material such as, but not limited to, plastic or acrylic or may include a transparent window near the location of a lock or locks when secured within the shroud. The transparent material or window enables a user to view the lock while locking and unlocking. This embodiment may be particularly useful for applications using combination locks.

Preferred embodiments of the present invention provide a lock shroud with more versatility than the prior art. For example, without limitation, a cable or a chain may be used with shrouds according to preferred embodiments. In a shroud according to a preferred embodiment, one lock or two locks may be accessed in the same shroud from either open end of the shroud with any lock or locks of choice.

Having fully described at least one embodiment of the present invention, other equivalent or alternative methods of providing a portable lock shroud according to the present invention will be apparent to those skilled in the art. The invention has been described above by way of illustration, and the specific embodiments disclosed are not intended to limit the invention to the particular forms disclosed. For example, the particular implementation of the slots may vary depending upon the particular type of chain or cable used. The slots described in the foregoing were directed to long and narrow implementations; however, similar techniques are to provide slots of various other shapes such as, but not limited to, circles or squares to match the type of cable or chain being used. For example, without limitation, a round slot may be used to accommodate a thick, round cable. Implementations of the present invention comprising various different types of slots are contemplated as within the scope of the present invention. The invention is thus to cover all modifications, equivalents, and alternatives falling within the spirit and scope of the following claims.

What is claimed is:

1. A portable shroud for a lock securing ends of a cable or chain, the shroud comprising:
a tubular element having sufficient interior dimensions to accommodate the lock and mitigate attempts to reach the lock with a cutting means, said tubular element having at least two slots for accepting the ends of the cable or chain where only the ends can be inserted into said tubular element for engaging with the lock.

2. The shroud as recited in claim 1, wherein said least two slots accept the ends only to a point of a cable feral or next chain link preventing the cable or chain from being pulled through said slots.

3. The shroud as recited in claim 2, further comprising at least one tube joined to said tubular element where an end of said tube covers said slots such that the ends of the cable or chain pass through said tube and said tube further mitigates attempts to reach the lock with the cutting means.

4. The shroud as recited in claim 3, wherein said at least one tube has an oval shape.

5. The shroud as recited in claim 2, further comprising at least two tubes joined to said tubular element where an end of each of said tubes covers said slots such that the ends of the cable or chain pass through said tubes and said tubes further mitigate attempts to reach the lock with the cutting means.

6. The shroud as recited in claim 5, wherein said at least two tubes have a rectangular shape.

7. The shroud as recited in claim 2, wherein said tubular element further comprises a plate joined to an end of said tubular element and said slots are contained in said plate.

8. The shroud as recited in claim 2, wherein said interior dimensions are further sufficient to accommodate two locks where each of said locks engages an end of the cable or chain allowing either end of the cable or chain to be removed from the shroud by disengaging the respective lock.

9. The shroud as recited in claim 2, wherein said slots are in opposition.

10. The shroud as recited in claim 2, wherein said tubular element has a generally rectangular shape.

11. The shroud as recited in claim 10, wherein said tubular element further comprises a plurality of round stock joined to internal corners of said tubular element for further mitigating attempts to reach the lock with the cutting means.

12. A portable shroud for a lock securing ends of a cable or chain, the shroud comprising:
means for accommodating the lock where said accommodating means mitigates attempts to reach the lock with a cutting means; and
means for accepting the ends of the cable or chain where only the ends can be inserted into said accommodating means.

13. The shroud as recited in claim 12, further comprising means for passing the ends of the cable or chain through for further mitigating attempts to reach the lock with the cutting means.

14. A portable shroud for a lock securing ends of a cable or chain, the shroud comprising:
a tubular element having sufficient interior dimensions to accommodate a plurality of locks where said dimensions mitigate attempts to reach the lock with a cutting means;
at least two slots for accepting the ends of the cable or chain where only the ends can be inserted into said tubular element for engaging with the locks and where either end of the cable or chain can be removed from the shroud by disengaging a respective one or more locks; and
at least two tubes joined to said tubular element where an end of each of said tubes covers said slots such that the ends of the cable or chain pass through said tubes and said tubes further mitigate attempts to reach the locks with the cutting means.

15. The shroud as recited in claim 14, wherein said least two slots accept the ends only to a point of a cable feral or next chain link preventing the cable or chain from being pulled through said slots.

16. The shroud as recited in claim 15, wherein said at least two tubes have a rectangular shape.

17. The shroud as recited in claim 15, wherein said tubular element further comprises a plate joined to an end of said tubular element and said slots are contained in said plate.

18. The shroud as recited in claim 15, wherein said slots are in opposition.

19. The shroud as recited in claim 15, wherein said tubular element has a generally rectangular shape.

20. The shroud as recited in claim 19, wherein said tubular element further comprises a plurality of round stock joined to internal corners of said tubular element for further mitigating attempts to reach the lock with the cutting means.
